(19) United States
(12) Patent Application Publication
(10) Pub. No.: US 2017/0002990 A1
(43) Pub. Date: Jan. 5, 2017

(54) LED SHOP LIGHT FOR MULTIPLE USES

(71) Applicant: CORDELIA LIGHTING INC., RANCHO DOMINGUEZ, CA (US)

(72) Inventors: AARON O'BRIEN, LOS ALAMITOS, CA (US); HUAN C. NGUYEN, PLACENTIA, CA (US)

(73) Assignee: CORDELIA LIGHTING INC., RANCHO DOMINGUEZ, CA (US)

(21) Appl. No.: 15/199,498

(22) Filed: Jun. 30, 2016

Related U.S. Application Data
(60) Provisional application No. 62/187,168, filed on Jun. 30, 2015.

(51) Int. Cl. F21S 8/06; F21V 7/22; F21K 9/275; F21V 23/04; F21K 9/278; F21V 21/008; F21V 23/02

(52) U.S. Cl. CPC F21S 8/061; F21V 21/008; F21V 7/22; F21V 23/023; F21V 23/04; F21K 9/278; F21K 9/275; F21Y 2115/10

(57) ABSTRACT

An elongated shop light suspended by cables from a ceiling, wherein the shop light includes an elongated light source such as a fluorescent tube or LED tube. The shop light has a rectangular shape with an interior cavity and an open bottom for receiving the light source and electrical hardware. One or more U-shape mounting brackets attach to the housing. Each mounting bracket has a plurality of internal grooves and a flat segment at the base of the U. The grooves function as attachment points when suspended to aim the light source straight down or at an angle. The flat segment of the mounting bracket acts as feet when the shop light is placed on the floor. The mounting bracket can also serve as a handle for the shop light.

### CROSS-REFERENCE TO RELATED APPLICATIONS

This application claims benefit of priority to provisional application no. 62/187,168, filed Jun. 30, 2015, the contents of which are hereby incorporated by reference.

### FIELD OF THE INVENTION

The present invention relates to residential and commercial lighting fixtures. In particular, the present invention relates to shop lights commonly found in a workshop, garage, game room, hobby area, and the like.

### BACKGROUND OF THE INVENTION

Shop lights are commonly known as ceiling suspended light fixtures. These light fixtures primarily use fluorescent tubes as the light source, but Light Emitting Diode (LEDs) are gaining popularity. Shop lights are used where intense lighting is desired, such as an auto mechanic's garage, a woodworking shop, a hobbyist's workbench area, a basement game room, a tool shed, a warehouse, etc., where intricate work is involved and bright lighting illuminating the work area is needed.

### SUMMARY OF THE INVENTION

An electrical shop light, supported by suspension means, cables, wires, and the like, to a ceiling, comprises a preferably elongated rectangular shape housing having opposite ends, an open bottom leading to an elongated interior cavity, and a top surface. A light source, such as a fluorescent tube, LED array, LED tube, neon tube, halogen bulb, or the like, is mounted to a receptacle disposed within the cavity. The interior cavity includes a light reflective means such as a reflective coating and/or a light reflector. An electrical power supply is disposed inside the cavity and energizes the light source. The power supply has an electrical cable that preferably extends out of the housing to connect to the house power line. An optional pull cable or chain leads from the power supply to the exterior of the housing and is used to control the on/off switch of the light source. A mounting bracket is disposed above the top surface of the housing and attached to the housing, wherein the mounting bracket includes a U-shape with a plurality of interior grooves, and wherein the mounting bracket is attached to the suspension means preferably at one of the grooves.

In a preferred embodiment, two U-shape mounting brackets are used. They are spaced apart from each other and positioned proximate the opposite ends of the rectangular housing. The suspension means hook or connect to one of the grooves of the mounting brackets. Preferably, there are three interior grooves at the base of the U, with two grooves spaced apart and a center groove therebetween. As such, the shop light can be suspended from the ceiling via the center groove so the light source fires directly downward; if suspended by either of the opposed grooves, then the shop light is aimed at angle to one side or the other.

The U-shape bracket may have a flat segment, an out-of-plane bend, or the like. In these embodiments, the U-shape bracket or brackets serve as feet or a floor stand for when the shop light is removed from the suspension means, flipped over, and placed on the floor to illuminate upward. Further, the U-shape mounting bracket acts as a convenient handle for the user to hold, aim, or transport the shop light. The U-shape of the mounting bracket may be replaced by a T-shape.

### BRIEF DESCRIPTION OF THE DRAWINGS

FIG. 1 is an end view of a preferred embodiment shop light suspended to a ceiling by a suspension means attached to a U-shape bracket.

FIG. 2 is a perspective end view of the shop light of FIG. 1.

FIG. 3 is an exploded view of the shop light shown in FIGS. 1 and 2.

FIG. 4 is a side perspective view of the shop light.

FIG. 5 is an alternative embodiment shop light having wire form mounting brackets.

FIG. 6 is another alternative embodiment shop light with wire form mounting brackets extending from the distal ends of the housing.

FIG. 7 is still another alternative embodiment having wire form mounting brackets that have an out-of-plane bend.

FIG. 8 shows an alternative embodiment mounting bracket having a T shape.

FIG. 9 shows an alternative embodiment mounting bracket having a T shape with a curved top crossbar and hooked ends.

### DETAILED DESCRIPTION OF THE PREFERRED EMBODIMENTS

A shop light generally refers to a linear, ceiling mounted light fixture that looks predominantly like the well-known fluorescent shop lights found in a garage, workshop, recreation room, work bench, and the like. It typically hangs from the ceiling on a set of chains, cables, wires, or like suspension means, and provides general lighting from that hanging position. Shop lights provide general illumination, are electrically powered by a cord from an AC source and some carry an additional switch operated by a pull cable or chain to shut down the power at the fixture. Shop lights were originally designed to operate a linear fluorescent lamp or tube. Each fixture has a ballast to operate the fluorescent lamp. Most often these fixtures have a reflector to help direct light from the top of the lamp down to the task area. The light distribution from one side of the fixture to the other, perpendicular with the lamp, is usually symmetrical. This hanging from the ceiling and firing straight down configuration, in one form or another, has persisted. Fluorescent tubes have now evolved to include LED arrays and LED tubes as the light source.

Lights for a shop area have grown to include portable work lights, under-the-hood lights, light fixtures firing upward for use under a car, stick lights that are hand held or hang from a singular hook, or attach with magnets. For a person who works on vehicles, it may take three or more light types to get the illumination job accomplished adequately.

The present invention in the preferred embodiments offers a single solution for multiple tasks and the ability to adjust the light so it directs light towards the work area rather than just emitting light straight down like conventional shop lights. The present invention shop light can be hand held, hung from one end, or set down on the floor firing upward to work under a vehicle. There are several embodiments which can achieve the desired effect with many options and configurations.

The preferred embodiment allows the shop light to hang at roughly a 30-degree angle, measured from the vertical centerline. In various embodiments, the shop light hangs from a single mounting point on either end of the fixture, may rest on the floor using the handles for support, may be hung to allow the light to be aimed straight down, or be held by hand.

The present invention shop light is preferably made from metal or plastic and some parts could be made from glass if needed, or any combination thereof. The light fixture can be hung from the ceiling by chains, cables, wires, straps, strings, rods, brackets, or similar suspension or support means. The handles can be removed from the shop light for replacement, changing their attachment locations, or for shipping purposes. The handles are attached to the shop light using screws, nuts, snaps, hooks, interference fits, pins, clamps, or the like mechanisms known in the art, and any combination thereof.

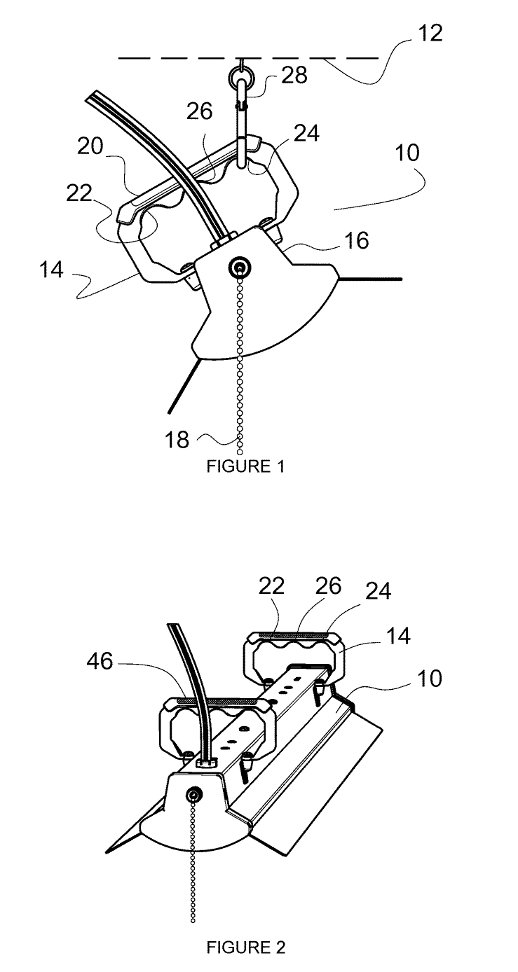

FIG. 1 is an end view of a preferred embodiment shop light 10, and FIG. 2 is a perspective view of the shop light 10 from FIG. 1 showing its top surface. The shop light 10 is hung from the ceiling 12 by suspension means 28 such as cables, chains, etc. known in the art. The suspension means engage one or more “C” or “U” shape mounting brackets or handles 14 that extend from the top of the shop light housing 16. An optional pull-chain or cable 18 is used to control the on/off power switch to the light source, and dangles vertically from gravity. The U-shape mounting brackets or handles 14 have preferably a U shape, and more specifically, a rectangular U shape. At the bottom or base 20 of the U are preferably three grooves 22, 24, 26. The grooves are located along the interior of the base of the U, with one groove 26 positioned at the center 26 and two grooves 22, 24, spaced apart at the two interior corners adjacent the legs of the U. In alternative embodiments, there can be more than three grooves or fewer than three grooves. Notches with more angular corners instead of grooves are contemplated as well.

As seen in FIG. 1, when hung from the ceiling 12 using standard suspension means 28 that hook to one of the corner grooves 24, gravity orients the shop light 10 and its emitted light is aimed at about a 30-degree angle from the vertical centerline (the pull chain 18 in the illustration). Other angles such as 45 degrees, 60 degrees, 90 degrees, etc. are contemplated, and can be accomplished by selective placement of the groove along the interior of the mounting bracket/handle 14. Instead of grooves, it is contemplated that the handle 14 may include eyelets or through-holes that provide suspension means access or latching points.

The shop light 10 when suspended as shown in FIG. 1 projects the light at an angle similar to a spotlight. Hanging the shop light 10 from one of the opposite corner grooves 22, 24 aims the light again at about a 30 -degree angle but in the opposite direction. Hanging the shop light at the center groove 26 orients it as with a conventional shop light firing straight down. If only one handle 14 is provided, the shop light 10 can be hung vertically from that handle at one end of the housing 16.

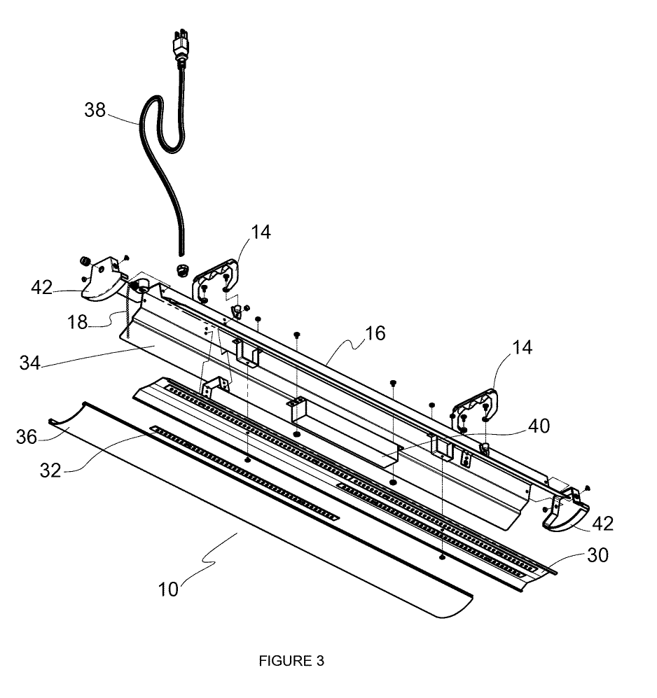

FIG. 3 is an exploded schematic view of a preferred embodiment shop light 10. There is a light source, and in this embodiment, it includes a circuit board 30 and mounted to it are LEDs that are part of an LED array 32. The circuit board 30 extends the length of the elongated, rectangular housing 16 and the LEDs are spaced along the length. The circuit board 30 is the receptacle for the LED light source 32 in this exemplary embodiment, but in an alternative embodiment, the receptacle corresponds to the sockets of a shop light fixture for receiving the end plugs on a fluorescent tube, for example.

An optional lens or diffuser 36 covers the LEDs and internal hardware. An electrical cable 38 leads power from the house AC source through a plug. Internal electronics 40 such as an LED driver, a voltage transformer, an AC-to-DC rectifier, a power supply, a ballast, etc. may be included to condition the house current to power the LEDs or other light source 32. Although the preferred light source 32 includes LEDs as shown, the shop light 10 may be configured for use with fluorescent tubes, halogen bulbs, neon tubes, LED tubes, incandescent light bulbs, LED bulbs, and the like.

The light source 32 and internal electronics 40 fit into a cavity of the housing 16, which has an open bottom. The interior of the cavity may include a light reflecting means 34 in the form of a coating of light reflective material or paint, and/or a layer or pane of light reflective sheeting functioning as a light reflector. The lens 36 covers the open bottom of the housing 16. The elongated rectangular shape of the housing is preferred, but other polygonal shapes are contemplated.

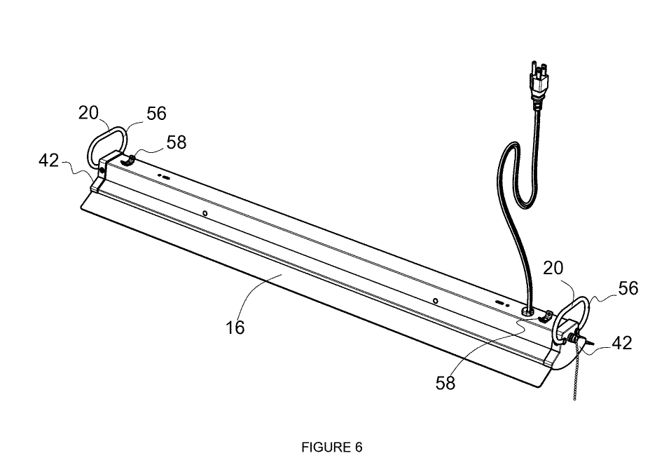

Preferably, two rectangular U-shape mounting brackets/handles 14 are attached to the top of the housing 16. The handles 14 are attached (and are detachable) with screws, rivets, or like fasteners to the housing 16 so there is no relative movement. In various alternative embodiments, the housing 16 may have other prefabricated attachment sites for mounting the handles 14 at different locations if desired by the end user. The attachment sites may be holes where fasteners can pass through to attach the handle, or the handle may have hooks, clips, snaps, etc. that latch on to the attachment site. Alternatively, the handles may be attached to the housing with hinges having detent stops to set the angle of the handle to the housing. V-brackets 58, described in further detail below and shown in FIG. 6, may be used to suspend the shop light 10 as well. There can me more or fewer handles 14 from what is shown in FIG. 3. End caps 42 cover the opposite distal ends of the housing 16.

Housing lengths range from 36 inches to 48 inches, preferably, to conform to industry standard T8, T12, T5, etc. sized fluorescent tubes or similarly sized LED tubes. Other preferred lengths are contemplated, including 18 inches to 24 inches, and still shorter or longer.

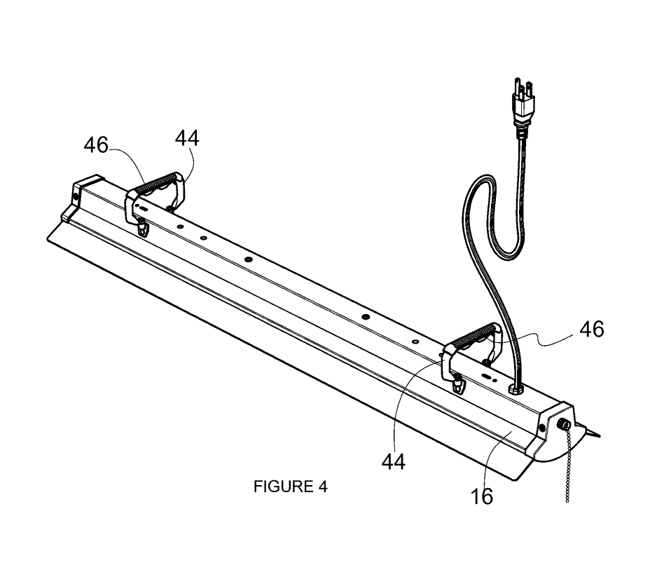

FIGS. 4-7 show various alternative embodiment shop lights where different forms of mounting brackets/handles are used. There are preferably two handles per fixture, but more or fewer handles than two can be used if desired. The handles are rigidly mounted to the housing using fasteners (FIG. 3) so as not to swivel, but it is contemplated that the handles may be mounted on a lockable swivel or hinge so that the handles can be flipped up or down and locked in either position. The handles are preferably bent steel or metal wire, or may have a tubular cross-section. The handles may be made from a rigid plastic, and may be partially or fully coated or covered with rubber, plastic, or the like.

FIG. 4 shows a steel mounting handle/handle 44 formed into an oblong or rectangular U-shape and mounted to the housing 16. The exterior surface 46 of the handle 44 is textured, contoured, knurled, rubber coated, and the like, providing a frictional grip surface if held in the hand; when laid against the ground, the textured surface minimizes unwanted sliding on a concrete floor, for example. FIG. 2 provides a close-up view of the textured surface 46, which is also noticeably flat. The flat, straight segment or portion 46 at the base 20 of the U-shape handle 14, 44 provides a stable base if the shop light 10 is laid upside down on the floor to illuminate the underside of a car lifted up on blocks, for example.

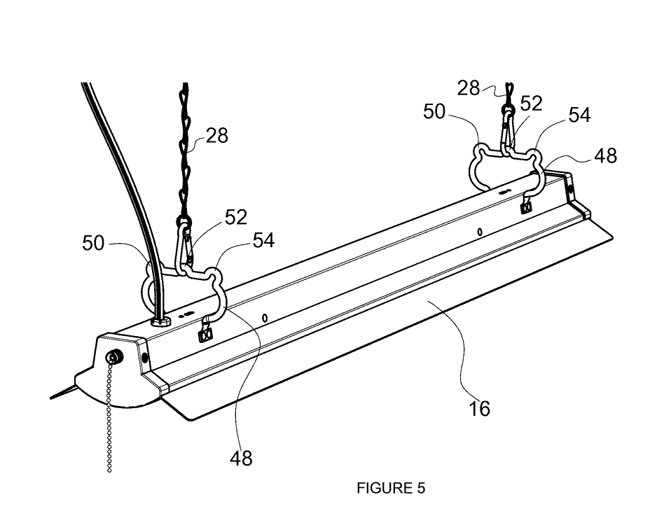

FIG. 5 shows an alternative embodiment mounting bracket/handle 48 having three grooves in the form of exterior protruding, partial loop bends or ears 50, 52, 54 where the suspension means 28 can catch or hook. The center bend or ear 52 is used in the illustration to suspend the shop light in the conventional manner with the light source emitting straight down. The other two bends 50, 54 can be used to angle the shop light to illuminate objects and areas at an angle. The three bends 50, 52, 54 are situated so that they have common tangents lying on a plane parallel to the elongated length of the shop light. This way, when the shop light is flipped upside down, the tangents of the bends 50, 52, 54 are all in common plane and act has feet resting on a flat surface such as the floor or work table.

FIG. 6 shows a simple ovoid shape mounting bracket/handle 56 with a flat section/straight segment 20 at the base of the U shape. The handle 56 can be bent from a steel wire (i.e., wire form) and is situated at the opposite ends 42 of the housing 16. The handle 56 has three grooves, i.e., the two bent legs of the U plus the base of the U.

Still in FIG. 6, the shop light may include two V-shaped brackets 58 mounted to the housing top surface at opposite ends as shown. Each V-bracket 58 includes through-holes. A cross bar or rod (not shown) can be inserted, with its axis oriented perpendicularly relative to the longitudinal length of the shop light, through the holes creating an enclosed circle or loop. The suspension means 28 then hooks or latches on to the enclosed circle or loop. When suspended by the cross bar, the suspension means 28 can slide to either end of the cross bar thus angling the shop light to one side or the other. The V-brackets 58 can be used instead of the handles, the handles may be omitted, or can remain in place for handheld use.

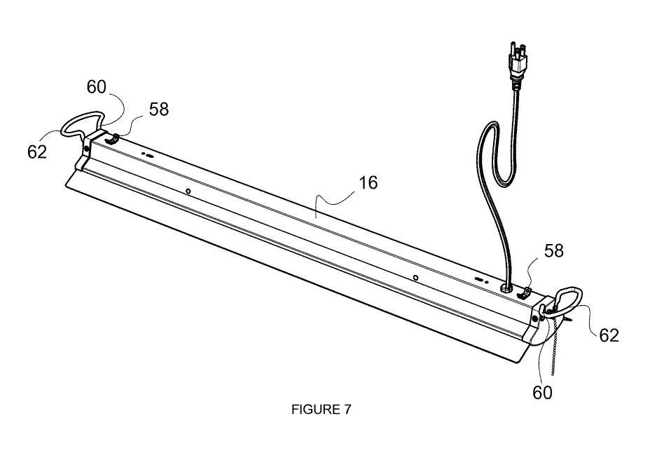

FIG. 7 shows alternative embodiment mounting bracket/handles 60 wherein the handle has an outward, out-of-plane bend 62. That is, the handle 60 when fashioned from wire into a U shape is contained in a first plane, and the base region of the U is then bent into a second plane different from the first plane. In the embodiment shown, the two planes intersect at about 90 degrees, but other bend angles such as 30, 45, and 60 degrees are contemplated. Slight kinks or bends in the loop of the handle close to the housing 16 serve as locations for the suspension means 28 to latch onto for an angular orientation, and the large bow of the loop of the handle 60 allows for the standard straight up and down suspension from the ceiling. The loop of the U shape handle 60 in this embodiment contains at least three grooves—two grooves located at the corner and a center groove that are all contained within the single continuous loop. V-brackets 58 are mounted to the top of this embodiment shop light.

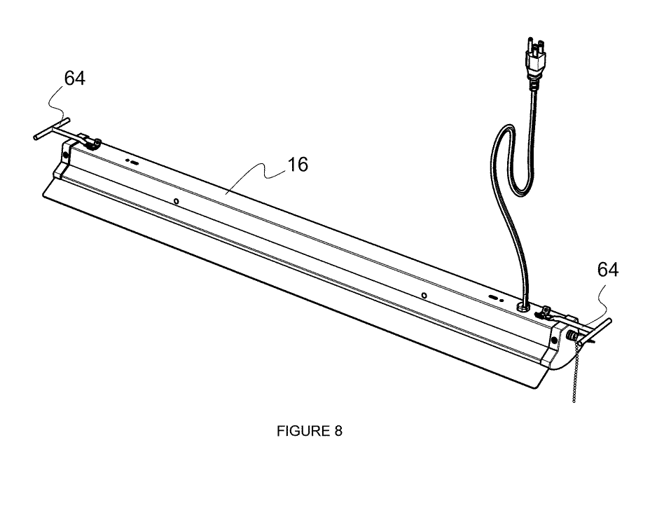

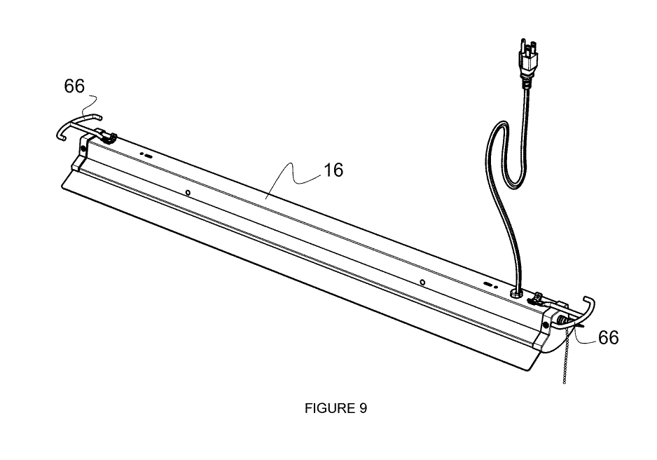

FIGS. 8 and 9 show two alternative embodiment mounting bracket/handles 64, 66 replacing the U shape with a T shape. FIG. 9 shows the T handle 64 with a curved crossbar top of the T with hooked ends while the FIG. 8 embodiment does not. In either instance, the suspension means 28 catches at a crotch or corner of the T for the angled orientation of the shop light, and hooks over the crossbars of the T (vertical meets horizontal arms) for a conventional straight up-and-down suspension orientation. As shown, the preferred orientation of the T handles 64, 66 is generally flush with or parallel to the plane containing the top surface of the housing. But the T handles 64, 66 may extend above the surface of the housing top as with the other handles described above.

While particular forms of the invention have been illustrated and described, it will be apparent that various modifications can be made without departing from the spirit and scope of the invention. It is contemplated that components from one embodiment may be combined with components from another embodiment.

What is claimed is:

1. An electrical shop light, supported by suspension means, comprising:
an elongated housing having an open bottom leading to an elongated interior cavity, and a top surface;
a receptacle to receive a light source, disposed within the cavity;
a light reflective means disposed within the interior cavity;
a power supply disposed inside the cavity and energizing the light source; and
a mounting bracket disposed above the top surface of the housing and attached to the housing, wherein the mounting bracket includes a U shape with a plurality of interior grooves, and wherein the mounting bracket is selectively attached to the suspension means at at least one of the interior grooves.

2. The electrical shop light of claim 1, wherein the light source includes at least one of a fluorescent tube, a halogen bulb, a neon tube, an LED array, and an LED tube.

3. The electrical shop light of claim 1, wherein the shop light includes at least two spaced apart mounting brackets; wherein the shop light includes a rectangular shape with opposite ends; and wherein the mounting brackets are located proximate to the opposite ends.

4. The electrical shop light of claim 1, wherein the light reflective means includes at least one of a light reflector and a light reflective coating.

5. The electrical shop light of claim 1, wherein the mounting bracket has a wire form and the grooves correspond to bends in the wire form.

6. The electrical shop light of claim 1, wherein the shop light includes a V-bracket having aligned holes through the legs of the V.

7. The electrical shop light of claim 1, wherein the mounting bracket has a wire form that includes an out-of-plane bend.

8. The electrical shop light of claim 1, wherein the mounting bracket includes three interior grooves located at the base of the U, wherein two of the grooves are spaced apart from each other and the third groove is located in between the other two grooves.

9. The electrical shop light of claim 1, wherein the mounting bracket includes a straight segment at the base of the U.

10. An electrical shop light, supported by suspension means, comprising:
an elongated, rectangular housing having opposite ends, an open bottom leading to an elongated interior cavity, and a top surface;
an elongated light source disposed within the cavity;
a light reflective means disposed in the interior cavity;
a power supply disposed inside the cavity and energizing the elongated light source;
a pull cable leading from a switch of the power supply to an exterior of the housing; and
a mounting bracket disposed above the top surface of the housing and attached to the housing, wherein the mounting bracket includes a U shape with a plurality of interior grooves, and wherein the mounting bracket is selectively attached to the suspension means at one of the interior grooves.

11. The electrical shop light of claim 10, wherein the shop light includes at least two mounting brackets spaced apart from each other and disposed above the top surface.

12. The electrical shop light of claim 10, wherein the cylindrical shape light source includes at least one of a fluorescent tube, a halogen bulb, a neon tube, an LED array, and an LED tube.

13. The electrical shop light of claim 10, wherein the mounting bracket includes a straight segment at the base of the U.

14. The electrical shop light of claim 10, wherein the mounting bracket includes a wire form and the grooves correspond to partial loop bends in the wire form.

15. The electrical shop light of claim 10, wherein the mounting bracket is attached to the housing so there is no movement relative to the housing.

16. The electrical shop light of claim 10, wherein the mounting bracket includes a straight segment and the straight segment includes a textured surface.

17. The electrical shop light of claim 10, wherein the shop light includes a lens covering the open bottom of the housing.

18. The electrical shop light of claim 10, wherein the housing includes a plurality of mounting sites for attachment of the mounting bracket.

19. An electrical shop light, supported by suspension means, comprising:
an elongated, rectangular housing having an open bottom leading to an elongated interior cavity, and a top surface;
a receptacle receiving an elongated light source, disposed within the cavity;
a light reflective means disposed within the interior cavity;
a power supply disposed inside the cavity and energizing the light source; and
at least two mounting brackets spaced apart from each other, disposed above the top surface of the housing and attached to the housing, wherein the mounting brackets include a U shape with a plurality of interior grooves, and wherein one of the mounting brackets via at least one of the grooves is attached to the suspension means.

20. The electrical shop light of claim 19, wherein the mounting bracket U shape is formed into a T shape.
